(19) United States
(12) Patent Application Publication
(10) Pub. No.: US 2017/0002718 A1
(43) Pub. Date: Jan. 5, 2017

(54) Integrated oil-less cylinder head engine

(71) Applicant: Thomas Lee Fillios, SR., Boston, MA (US)

(72) Inventor: Thomas Lee Fillios, SR., Boston, MA (US)

(73) Assignee: Thomas Lee Fillios, SR., Boston, MA (US)

(21) Appl. No.: 15/330,150

(22) Filed: Aug. 16, 2016

Related U.S. Application Data
(63) Continuation-in-part of application No. 14/121,209, filed on Aug. 12, 2014, now abandoned.

(51) Int. Cl. F01P 3/22; F02B 75/18; F01P 3/02; F02P 13/00; F02F 11/00; F02F 1/00; F02F 1/02; F02F 7/00; F02F 1/42; F02B 75/32; F02D 41/26

(52) U.S. Cl. CPC F01P 3/22; F02B 75/32; F02B 75/18; F01P 3/02; F02P 13/00; F02D 41/26; F02F 1/002; F02F 1/02; F02F 7/0085; F02F 1/42; F02F 11/002; F02F 11/007; F01P 2003/024; F02B 2075/1812

(57) ABSTRACT

An oil-less engine with an integrated cylinder head is described. Oil-less engine allows manufacturers to build environmentally safer oil-free engines, with fewer engine parts and at reduced costs of manufacturing. In one embodiment, the present invention an internal combustion engine comprising a reciprocating cradle having pistons. The cradle is assembled with a circular disk that rotates. The rotation of the circular disk causes the pistons and the cradle to reciprocate and thereby causing a combustion with cylinder heads.

### REFERENCE TO RELATED APPLICATIONS

This application is a Continuation-In-Part (CIP) and claims the benefit of earlier filed and co-pending application U.S. Ser. No. 14/121,209 filed on Aug. 12, 2014, entitled “RECIPROCATING CRADLE ENGINE,” the entire disclosure of which is hereby incorporated by reference herein.

### FIELD

Embodiments of the present invention relate generally to engines and motors. More specifically, embodiments of present invention relate to oil-less cylinder head and oil-less engine.

### BACKGROUND

Prior art engines and cylinder heads often utilize engine oil for lubricating pistons and cylinder walls. Engine oil produces pollutants, causing pollution to environment. Prior art engines and cylinder head also comprise numerous moving or wearable parts. Such parts include, but are not limited to, nuts and bolts, pushrods, valves, lifters, rod bearings, rockers, rocker posts, springs, chains, sprockets, sprocket covers and head gasket. These parts contribute to the issues of increased size and weight, lower reliability, and higher costs of manufacturing. Given the aforementioned issues, prior art engines and cylinder heads have insufficient environmental safety, reliability and economics in manufacturing.

### SUMMARY

The present invention improves environmental safety standards of internal combustion engines by eliminating the use of engine oil in the internal combustion area of an engine, thus reducing pollutants and increasing environmental safety. The invention reduces the number of parts used in a cylinder head and an engine, thereby minimizing engine weight and lowering the costs of production. The present invention also increases reliability and efficiency of a cylinder head and an engine by reducing the number of wearable engine parts that include, but are not limited to, camshafts, valves, lifters, rod bearings, rockers, springs, sprockets and head gasket.

In one embodiment, the present invention is an oil-less internal combustion engine comprising an integrated cylinder head, the engine comprising: (a) an engine casing comprising a cradle; (b) said cradle comprising a plurality of pistons, each piston connected to said cradle by a piston rod; (c) a plurality of cylinder walls corresponding to said plurality of pistons, wherein each cylinder wall comprises an integrated cylinder head, and wherein said each cylinder wall is adapted to hold said each piston; (d) a circular disk assembled in said cradle, wherein said disk is adapted to rotate, and wherein said cradle performs a reciprocation when said disk rotates; and (e) a crankshaft connected to said disk, wherein said crankshaft is adapted to transfer mechanical power to a transmission, wherein said oil-less engine, in the inside of said engine casing, is free of lubrication, wherein said integrated cylinder head, corresponding to said each cylinder wall, is screwably mountable into said engine casing, said cylinder head comprises: an externally-grounded sparking means comprising a positive terminal and a negative terminal; a fuel injecting means; an air injecting means; a valve-less electronic exhaust eliminator; a means for cooling said cylinder head, wherein said means for cooling comprises a screw-in air conditioning (AC) module; wherein said sparking means, said fuel injecting means, said air injecting means, said electronic exhaust eliminator, and said means for cooling are fitted together in a screw-type assembly into said cylinder head, wherein said cylinder head is free of lubricating agent, and wherein said cylinder head is valve less.

Other embodiments of the present invention are described in the detailed description below.

### BRIEF DESCRIPTION OF THE DRAWINGS

The embodiments of the present invention described herein are exemplary, and not restrictive.

FIG. 1 is an embodiment identifying engine sections of an engine of the present invention, when the cradle is down.

FIG. 2 is an embodiment identifying engine sections of an engine of the present invention, when the cradle is up.

FIG. 3A is an embodiment of an exhaust eliminator when the exhaust is closed.

FIG. 3B is an embodiment of an exhaust eliminator when the exhaust is opened.

FIG. 4A is an embodiment of the engine of the present invention when a piston is in up position.

FIG. 4B is an embodiment of the engine of the present invention when a piston is in down position.

FIG. 5 is an embodiment of the engine showing a plurality of air conditioning (AC) modules and a plurality of coolant jackets in the engine casing of the present invention.

FIG. 6 is an embodiment of the engine of FIG. 1 showing an electric spark (spark tip).

FIG. 7 is an embodiment of an integrated cylinder head.

FIG. 8 is an embodiment of the base of an integrated cylinder head.

FIG. 9 is an embodiment of the tip of an integrated cylinder head.

FIG. 10 is an embodiment of an electronic exhaust eliminator.

FIG. 11 is an embodiment of an integrated cylinder head and a curved shaped piston.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Advantageously, the present invention improves environmental safety of internal combustion engine by eliminating the use of engine oil from the internal combustion area of an engine, thus reducing pollutants. Further, the invention reduces the number of engine parts of prior art engines, thereby minimizing engine weight and lowering the costs of production. The present invention also increases reliability and efficiency of an engine by reducing the number of wearable engine parts that include, but are not limited to, camshafts, valves, lifters, rod bearings, rockers, springs, and sprockets.

Broadly, in one embodiment, the present invention is an oil-less internal combustion engine comprising an integrated cylinder head, the engine comprising: (a) an engine casing comprising a cradle; (b) said cradle comprising a plurality of pistons, each piston connected to said cradle by a piston rod; (c) a plurality of cylinder walls corresponding to said plurality of pistons, wherein each cylinder wall comprises an integrated cylinder head, and wherein said each cylinder wall is adapted to hold said each piston; (d) a circular disk assembled in said cradle, wherein said disk is adapted to rotate, and wherein said cradle performs a reciprocation when said disk rotates; and (e) a crankshaft connected to said disk, wherein said crankshaft is adapted to transfer mechanical power to a transmission, wherein said oil-less engine, in the inside of said engine casing, is free of lubrication, wherein said integrated cylinder head, corresponding to said each cylinder wall, is screwably mountable into said engine casing, said cylinder head comprises: an externally-grounded sparking means comprising a positive terminal and a negative terminal; a fuel injecting means; an air injecting means; a valve-less electronic exhaust eliminator; a means for cooling said cylinder head, wherein said means for cooling comprises a screw-in air conditioning (AC) module; wherein said sparking means, said fuel injecting means, said air injecting means, said electronic exhaust eliminator, and said means for cooling are fitted together in a screw-type assembly into said cylinder head, wherein said cylinder head is free of lubricating agent, and wherein said cylinder head is valve less.

Technical know-how, functionalities and operation of prior art engines are known to a person of ordinary skill in the art of engine making. The description herein focuses on novelty in a manner that the solution concept of the present invention is discernable from prior art engines. Embodiments covering dimensions and engineering specifications of the present invention are not restrictive, meaning inclusive, to the present invention. Dimensions and engineering specifications are known to a person of ordinary skilled in the art. Dimensions and specification are customizable.

For the purpose of the present invention, the term “oil-less” is used to describe an engine that does not use engine oil for lubrication in its internal combustion area. However, oil or lubricating agents may be used outside of internal combustion area for lubricating mechanical assembly, such as, crankshaft and crankshaft holder.

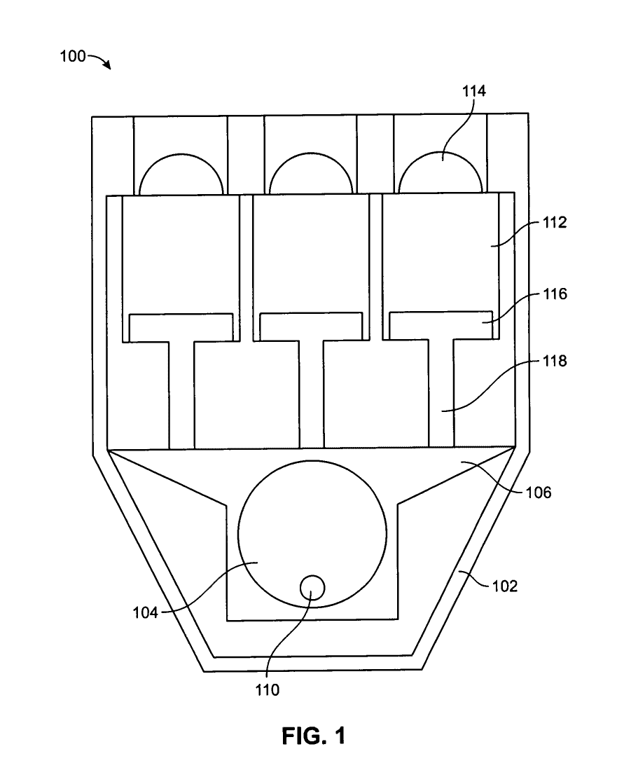

With reference to FIG. 1 to FIG. 11, embodiments of an engine of the present invention are described below. The phrase “an embodiment” refers to an embodiment of an engine of the present invention.

FIG. 1 is an embodiment 100 showing parts of engine of the present invention. An engine casing 102 holds a cradle 106. The cradle 106 houses a disk 104. The disk 104 rotates either clockwise or counterclockwise. The cradle is adapted in a way that when the disk 104 rotates, the cradle moves up and down or reciprocates. In one embodiment, the cradle is adapted to reciprocate using a worm drive or assembly. The cradle comprises a rack gear and the disk comprises a worm gear (drive). In another embodiment, reciprocation of the cradle is enabled by a roller(s), the roller being adapted between the inside wall of the engine casing and the cradle. Rolling wheels may facilitate reciprocation. A sliding mechanism may also be adapted to facilitate reciprocation. The cradle 106 also holds a plurality of pistons. A piston 116 has a piston rod 118. The piston rod 118 maybe screwed into the cradle 106. The piston 116 moves along a cylinder wall 112. The upper part of the cylinder wall 112 has a cylinder head 114 (also called, a combustion chamber). The combustion chamber 114 comprises a fuel injector, an air injector, a sparking means and an exhaust means (exhaust eliminator). At 110, a crankshaft connects to the disk 104. The disk when rotates will cause the crankshaft to transfer mechanical power to a transmission. The embodiment 100 shows the parts of the engine when the cradle 106 is in down position.

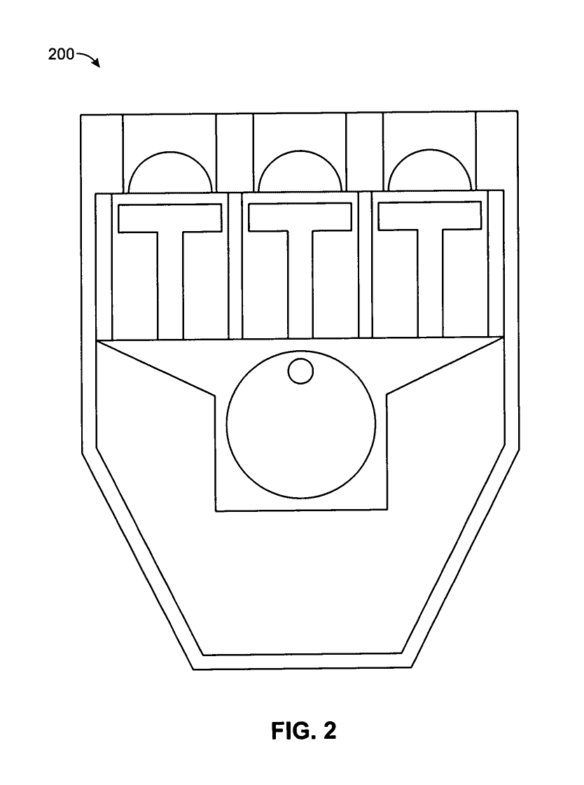

FIG. 2 is an embodiment 200 showing parts of engine of the present invention, when the cradle is in up position. When the cradle is in up position, a combustion may commence at combustion chambers.

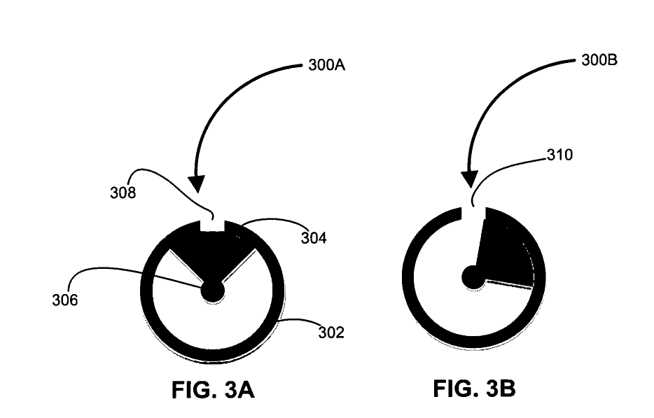

FIG. 3A is an embodiment 300A of an exhaust eliminator when the exhaust is closed or sealed off. The exhaust eliminator may be electronically controlled by a car computer. An exhaust sealer 304 rotates around an axis 306 inside the perimeter 302, thereby sealing off the opening 308.

FIG. 3B is an embodiment 300B of an exhaust eliminator when the exhaust is open. When the exhaust is open, the opening 310 is unobstructed by the exhaust sealer.

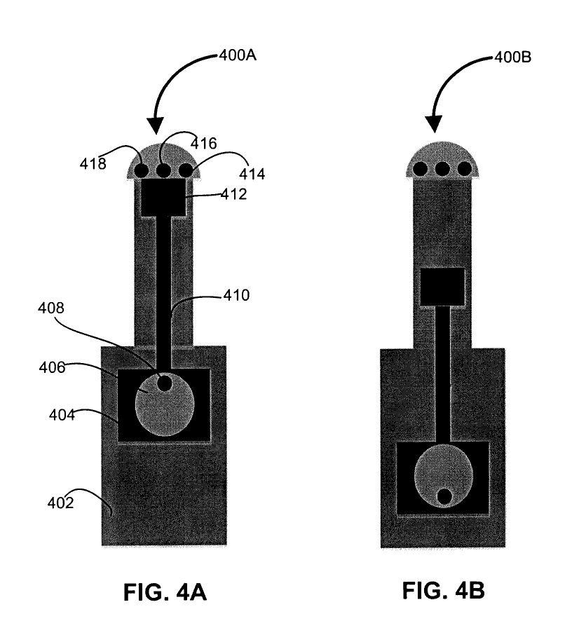

FIG. 4A is an embodiment 400A of a cradle and a single piston of the present invention, when the piston is in up position. A cradle 404 moves inside the engine casing 402. A rotation of a disk 406 causes the cradle 404 to move along the casing 402. A worm drive is implemented between the cradle and the disk to cause a reciprocation of the cradle when the disk rotates. A piston rod 410 comprising a piston 412 is screwed into the cradle 404. A combustion chamber comprises an fuel injector 418, an air injector 416, a sparking means and an exhaust means (exhaust eliminator). A crankshaft 408 is connected to the disk 406. The crankshaft transfers mechanical power from the disk to a transmission when the disk generates mechanical power by rotation. The disk rotates when a combustion happens. A piston rod 410 connects a piston 412 to the cradle 404. A cylinder head (or combustion chamber) comprises a sparking means 418, an air injector 416, and a fuel injector 414. The cylinder head also comprises an exhaust means or exhaust eliminator that is electrically controlled by a car computer. When the piston 412 approaches the cylinder head, a combustion happens, causing the piston to move down, thereby rotating the disk 406.

FIG. 4B is an embodiment 400B of a cradle and a single piston of the present invention, when the piston is in down position. When the piston is down, a mixture of fuel and air is formed inside the cylinder wall. As the piston moves up, the mixture is compressed. When the piston is at a top dead center position, a combustion happens. The cylinder wall may be made of composite materials.

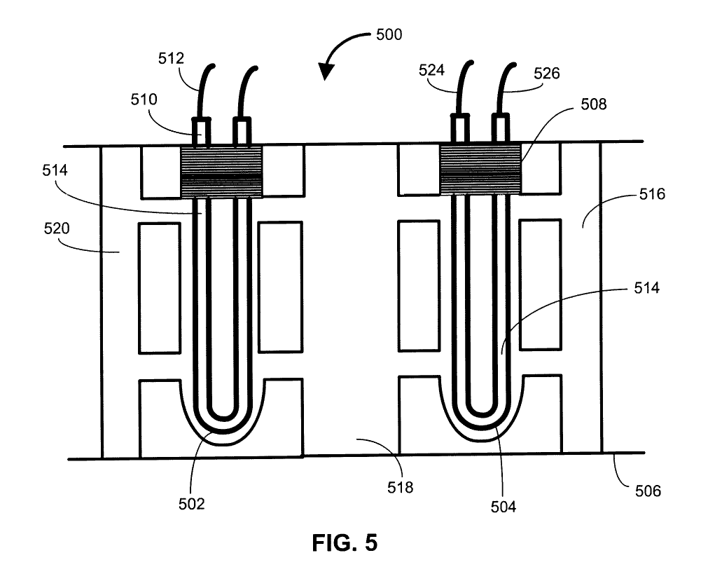

FIG. 5 is an embodiment 500 showing a plurality of air conditioning (AC) modules (502 and 504). AC modules are used optionally, in addition to coolant (at coolant jackets) in an engine casing, to improve the process of heat elimination from the casing. An AC module 504 is screwed on to a coolant hole 508 of an engine casing 506. An AC module has an inlet 524 and an outlet 526 for air conditioning (AC) fluid to pass. An inlet or outlet comprises an oil fitting and an oil tubing. An oil fitting 510 along with an oil tubing 512 transfers AC fluid to the AC module 502 from an AC condenser. An AC condenser of an automobile air conditioner may be used for the application discussed herein. An AC module has a pipe 514 that connects an inlet 524 to an outlet 526. Alternatively, coils may be used in place of a pipe. AC fluid passing through a pipe or coils transfers heat out from the engine casing 506. The engine casing 506 has a plurality of coolant jackets (516, 518, 520). A combination of coolant jackets and AC modules operate to maintain the temperature of the engine casing 506. Further, the engine casing may comprise refrigeration coil having refrigerant for cooling.

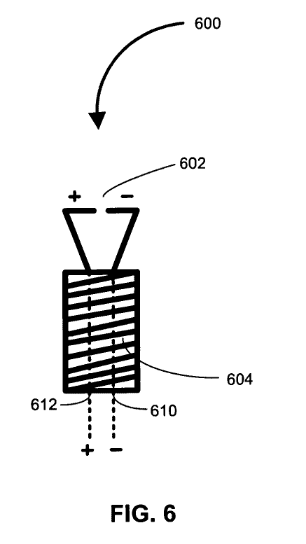

FIG. 6 is an embodiment 600 showing a spark tip of a spark plug or sparking means. A positively charged wire and a negatively charged wire create a spark at 602 where the positively charged wire and the negatively charged wire meet together. Electricity is passed through the spark rod to the spark tip by using insulated wires: a positive wire 612 and a negative wire 610 (externally grounded).

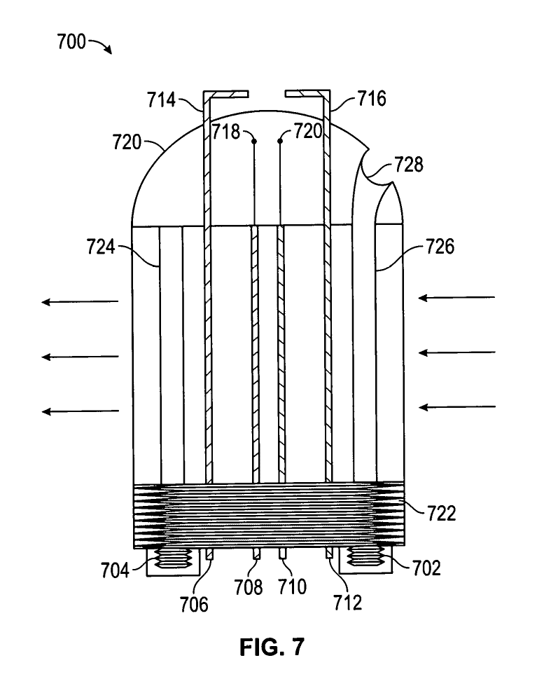

FIG. 7 is an embodiment 700 of an integrated cylinder head. The cylinder head comprises screw on parts, comprising an air injector 710, a fuel injector 708, an externally grounded spark plug comprising a positive terminal 712 and negative terminal 706, an electronic exhaust eliminator 702, and an air conditioning module 704. The cylinder head is valve-less and oil-less. The cylinder head uses no lubricating agent for lubrication. The cylinder head may be constructed of porcelain and metal clad. The cylinder head comprises an air conditioning module for reducing temperature or dissipating heat. The screw-on parts may be fitted together with the cylinder head using a screw-type assembly, thus, eliminating nuts and bolts type assembly. The spark plug may be externally grounded. The body of the cylinder head comprises threads 722 which may be used to screw the cylinder head into an engine casing.

The tip 720 of the cylinder head 700 is dome shaped. The tip has a first outlet for the electronic exhaust eliminator. The externally grounded spark plug creates a spark by engaging a positive terminal 716 and a negative terminal 714. The nozzle 718 of the fuel injector and the nozzle 720 of the air injector are appropriately positioned on the dome shaped tip 720 of the cylinder head. The threaded area 722 comprises a second outlet (not shown in the diagram) for the electronic exhaust eliminator.

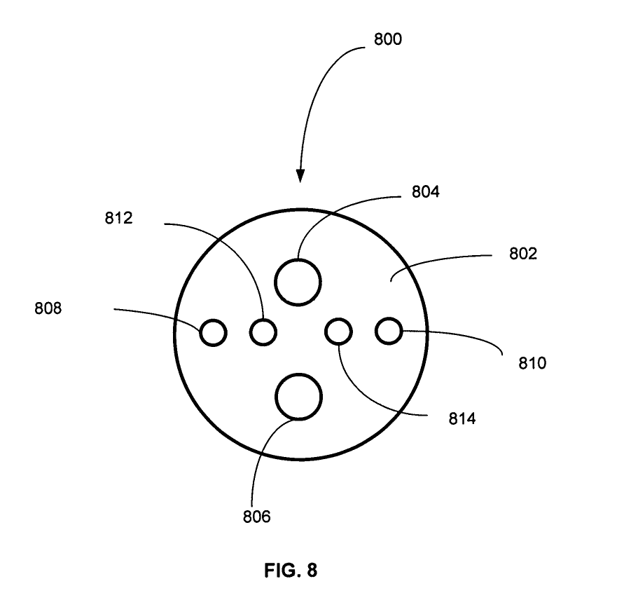

FIG. 8 is an embodiment 800 showing the base of an integrated cylinder head. The base 802 of the cylinder head comprises an air injector 812, a fuel injector 814, a positive charged terminal 808 and negative charged terminal 810 for an externally grounded spark plug, an electronic exhaust eliminator 804 and an air conditioning module 806.

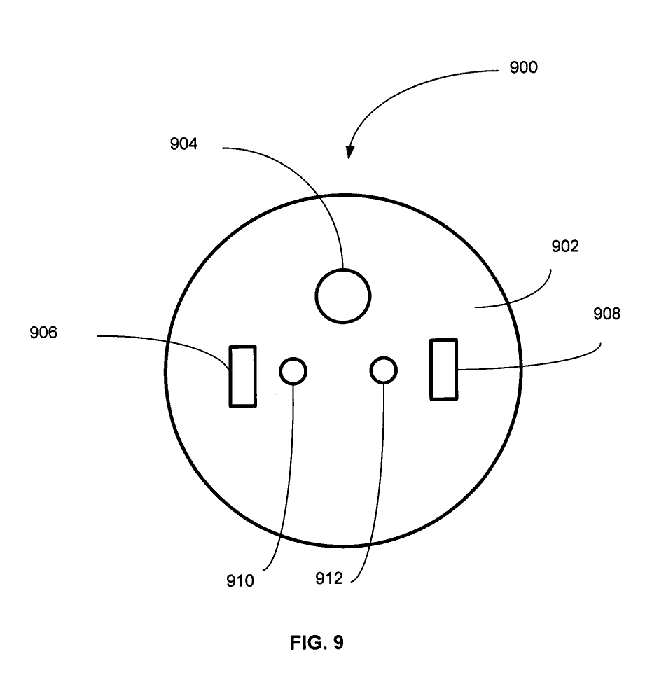

FIG. 9 is an embodiment 900 showing the dome shaped tip of an integrated cylinder head. The tip comprises an air injector 910, a fuel injector 912, a positive charged terminal 906 and negative charged terminal 908 for an externally grounded spark plug, and an electronic exhaust eliminator 904.

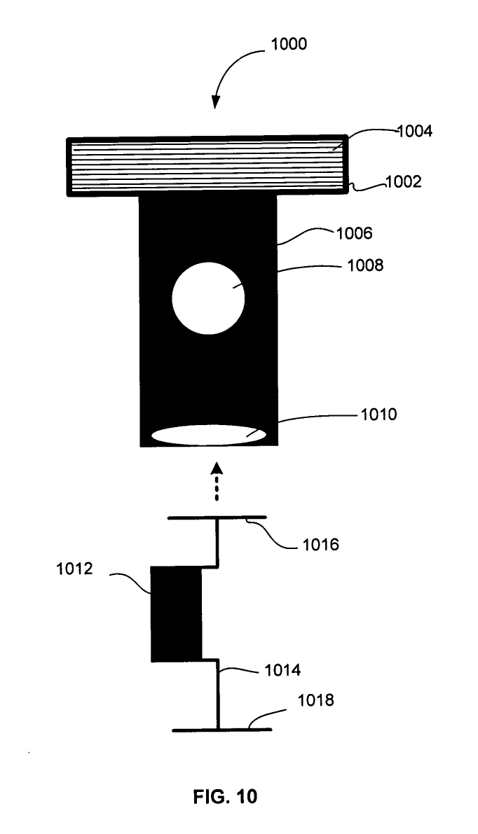

FIG. 10 is an embodiment 1000 of an electronic exhaust eliminator (EEE). FIG. 10 is a screw-type exhaust eliminator 1002. The EEE has threads 1004 and a tube 1006. The tube has an upper hole 1008 and a lower hole 1010 to allow a flow of exhaust fumes. The tube 1006 is fitted with a paddle 1012 that rotates on an axis 1014. The hole 1008 is accommodated with the paddle 1012 in a way that the rotation of the paddle within the tube 1006 causes the hole 1008 to open and to close. The paddle 1012 is secured inside the tube 1006 using two bars 1016 and 1018. The bars 1016 and 1018 may be shouldered to the inner wall of the tube 1006. The rotation of the paddle causes opening and closing of the upper hole. The paddle has a pad. The pad operates to seal the upper hole. The rotation of pad (along with the paddle) causing opening or closing of the upper hole. The rotation of the pad is electronically programmable using a car computer.

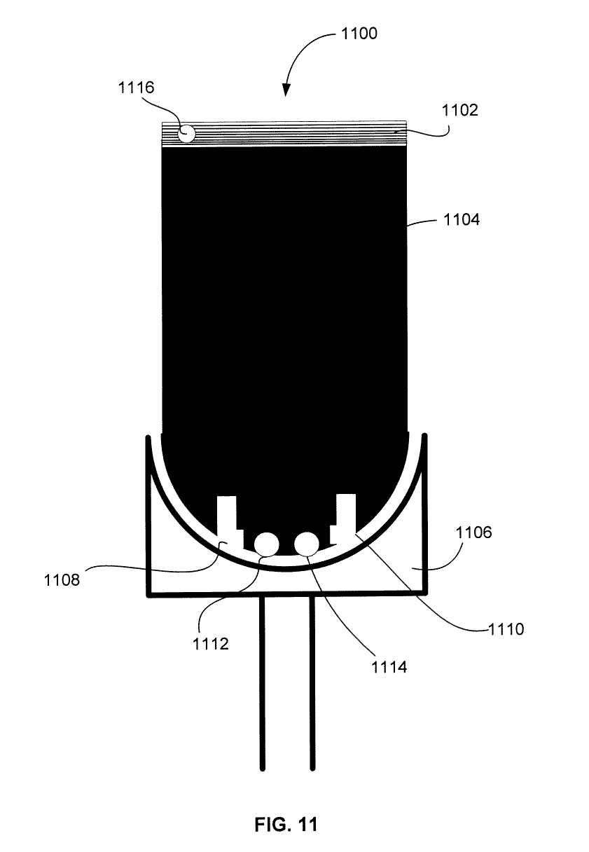

FIG. 11 is an embodiment 1100 showing an integrated cylinder head. The integrated cylinder head is engaged with a curved shaped piston 1106. The dome shaped tip of the cylinder head engages with a curved shaped piston 1106. The integrated cylinder head 1104 is screwed into an engine casing using threads 1102. The threaded area 1102 also comprises an outlet 1116 for an electronic exhaust eliminator. The dome shaped tip of the cylinder head comprises an air injector 1112, a fuel injector 1114, a positive charged terminal 1108 and negative charged terminal 1110 for an externally grounded spark plug.

Embodiments of the present invention may use a screw-type or screw-on assembly of modular engine parts. However, a person of ordinary skill in the art knows that alternative means of attachment, such as, nuts and blots, may be used to achieve identical functionalities of the present invention. In another embodiment, two or more engine parts of the present invention may be casted in a single mold, thus avoiding a screw-on assembly or nut and bolt assembly.

Reference in this specification to “one embodiment” or “an embodiment” means that a particular feature, structure, or characteristic described in connection with the embodiment is included in at least one embodiment of the invention. The appearance of the phrases “in one embodiment” or “an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Although the written description contains many specifics for the purposes of illustration, anyone skilled in the art will appreciate that many variations and/or alterations to the details are within the scope of the present invention. Similarly, although many of the features of the present invention are described in terms of each other, or in conjunction with each other, one skilled in the art will appreciate that many of these features can be practiced independently of other features. Accordingly, the description of the invention is set forth without any loss of generality to, and without imposing limitations upon, the invention.

Although the present invention has been described with reference to specific exemplary embodiments, it will be evident that various modification and changes can be made to these embodiments without departing from the broader spirit of the invention. Accordingly, the specification and drawings are to be regarded in an illustrative sense rather than in a restrictive sense.

1. An oil-less internal combustion engine comprising an integrated cylinder head, the engine comprising:
(a) an engine casing comprising a cradle;
(b) said cradle comprising a plurality of pistons, each piston connected to said cradle by a piston rod;
(c) a plurality of cylinder walls corresponding to said plurality of pistons, wherein each cylinder wall comprises an integrated cylinder head, and wherein said each cylinder wall is adapted to hold said each piston;
(d) a circular disk assembled in said cradle, wherein said disk is adapted to rotate, and wherein said cradle performs a reciprocation when said disk rotates; and
(e) a crankshaft connected to said disk, wherein said crankshaft is adapted to transfer mechanical power to a transmission,
wherein said oil-less engine, in the inside of said engine casing, is free of lubrication,
wherein said integrated cylinder head, corresponding to said each cylinder wall, is screwably mountable into said engine casing, said cylinder head comprises:
(i) an externally-grounded sparking means comprising a positive terminal and a negative terminal;
(ii) a fuel injecting means;
(iii) an air injecting means;
(iv) a valve-less electronic exhaust eliminator;
(v) a means for cooling said cylinder head, wherein said means for cooling comprises a screw-in air conditioning (AC) module;
wherein said sparking means, said fuel injecting means, said air injecting means, said electronic exhaust eliminator, and said means for cooling are fitted together in a screw-type assembly into said cylinder head,
wherein said cylinder head is free of lubricating agent, and
wherein said cylinder head is valve less.

2. The engine of claim 1, wherein said cradle is adapted to reciprocate using a rack and worm assembly, wherein said cradle comprises a rack gear and said disk comprises a worm gear, and wherein said reciprocation of said cradle causes said plurality of pistons to reciprocate along said plurality of cylinder walls.

3. The engine of claim 1, wherein said plurality of pistons, when at reciprocation, do not leave said plurality of cylinder walls.

4. The engine of claim 1, wherein said plurality of cylinder walls are made of composite materials.

5. The engine of claim 1, wherein said engine casing comprises a second air conditioning (AC) module.

6. The engine of claim 1, wherein said reciprocation of said cradle is enabled by a roller, and said roller is adapted between the inside wall of said engine casing and said cradle.
